(19) United States
(12) Patent Application Publication
(10) Pub. No.: US 2004/0136590 A1
(43) Pub. Date: Jul. 15, 2004

(54) Means of partitioned matching and selective refinement in a render, match, and refine iterative 3D scene model refinement system through propagation of model element identifiers

(76) Inventor: Albert-Jan Brouwer, Delft (NL)

Correspondence Address: Albert-Jan Brouwer, St. -Eustatiusstraat 2, Delft, 2612 HA, NL

(21) Appl. No.: 10/659,319

(22) Filed: Sep. 11, 2003

Related U.S. Application Data
(60) Provisional application No. 60/412,008, filed on Sep. 20, 2002.

(51) Int. Cl. G06K 9/00

(52) U.S. Cl. 382/154

(57) ABSTRACT

The present invention is an enhancement of the render, match, and refine (RMR) method [0002] for scene model refinement. It provides a means of automatically subdividing the RMR problem such that the matching can operate on subsets of the 2D view plane, and refinement can operate on subsets of the scene model parameters with little interference between parameter subsets. Since run times of high-dimensional searches tend to scale exponentially with the number of dependent parameters and linearly with the number of independent parameters, this can vastly reduce the number RMR iterations required to achieve convergence.

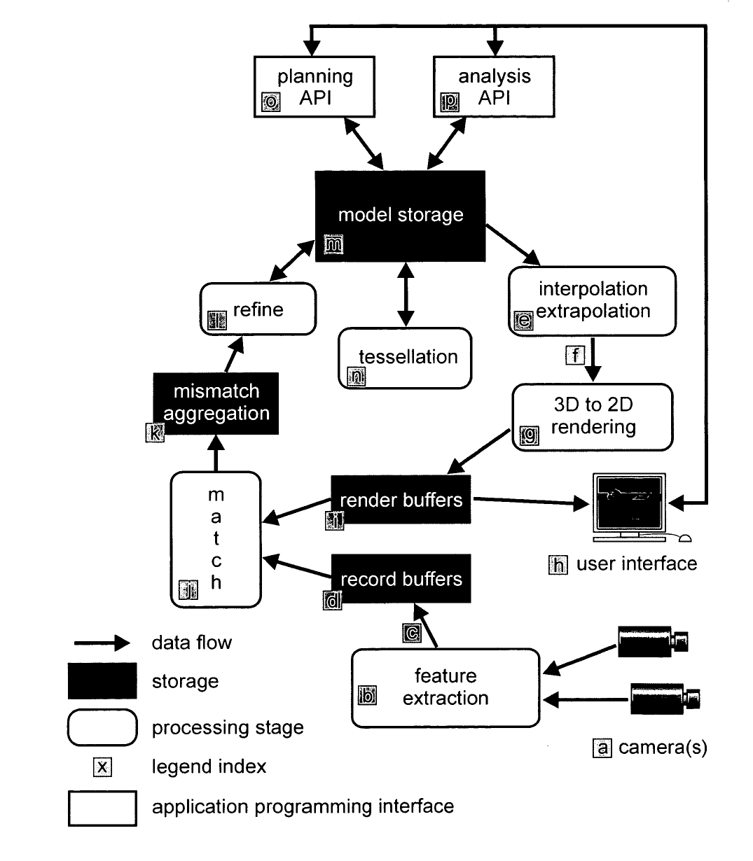

### CROSS-REFERENCE TO RELATED APPLICATIONS

[a] The present invention claims priority benefit of United States Provisional Patent Application Serial No. 60/412,008, filed Sep. 20, 2002 (same title as present application), which is hereby incorporated by reference.

[b] This application is related to co-pending and simultaneously filed U.S. patent application Ser. No. 10/659,280 entitled “Means of matching 2D motion vector fields in a render, match, and refine iterative 3D scene model refinement system so as to attain directed hierarchical convergence and insensitivity to color, lighting, and textures”, which is hereby incorporated by reference.

### BACKGROUND OF THE INVENTION

Automated 3D scene model refinement based on camera recordings has at least three application domains: computer vision, video compression, and 3D scene reconstruction.

The render, match, and refine (RMR) method for 3D scene model refinement involves rendering a 3D model to a 2D frame buffer, or a series of 2D frames, and comparing these to images or video streams recorded using one or more cameras. The mismatch between the rendered and recorded frames is subsequently used to direct the refinement of the scene model. The intended result is that on iterative application of this procedure, the 3D scene model elements (viewpoint, vertices, NURBS, lighting, textures, etc.) will converge on an optimal description of the recorded actual scene. The field of analogous model-based methods of which the RMR method is part is known as CAD-based vision.

Many implementations of 3D to 2D rendering pipelines exist. These perform the various steps involved in calculating 2D frames from a 3D scene model. When motion is modeled, model parameters that encode positions and orientations are made time dependent. Rendering a frame starts with interpolating the model at the frame time, resulting in a snapshot of positions and orientations making up the (virtual) camera view and geometry. In most rendering schemes, the geometry is represented by meshes of polygons as defined by the positions of their vertices, or translated into such a representation from mathematical or algorithmic surface descriptions (tessellation). Subsequently, the vertex coordinates are transformed from object coordinates to the world coordinate system and lighting calculations are applied. Then, the vertices are transformed to the view coordinate system, which allows for culling of invisible geometry and the clipping of the polygons to the view frustum. The polygons, usually subdivided in triangles, are then projected onto the 2D view plane. The projected triangles are rasterized to a set of pixel positions in a rectangular grid. At each of these pixel positions the z value, a measure for the distance of the surface to the camera, is compared to any previous values stored in a z buffer. When smaller, that part of the surface was in front of anything previously rendered to the same pixel position, and the corresponding z value is overwritten. The co-located pixel in the render buffer holding the color values is then also updated. The color is derived from an interpolation of the light intensities, colors, and texture coordinates of the three vertices making up the triangle.

In recent years, increasingly capable and complete hardware implementations of the rendering steps outlined under [0003] have emerged. Consequently, 3D to 2D rendering performance has improved in leaps and bounds. A compelling feature of the RMR method [0002] is that it can leverage the brute computational force offered by these hardware implementations and benefit from the availability of large amounts of memory. The main problem with the RMR method is the large number of parameters required for a 3D scene model to match an observed scene of typical complexity. These model parameters constitute a high-dimensional search space, which makes finding the particular set of parameters constituting the best match with the observed scene a costly affair involving many render, match, and refine iterations. The present invention reduces this cost.

The word “identifier” is used to describe a data item that allows the quick access of an associated data structure or parameter in the 3D scene model, e.g. a pointer, reference, handle, hash key, or similar.

The phrase “render buffer” is used to indicate a generalisation of a frame buffer that can in principle hold arbitrary rendering derived data items, such as identifiers. A render buffer need not necessarily be structured in the same way as the frame buffer, but can be assumed to be accessible via the same 2D frame coordinates as the frame buffer so that 2D co-located data items in render buffers and the frame buffers can be accessed in unison.

### SUMMARY OF THE INVENTION

The invention is based on the observation that separate geometry objects in a 3D scene model are unlikely to overlap in an arbitrary 2D view of that scene, that is, objects tend to be rendered to different parts of the 2D view. The mismatch of a particular part of the rendered 2D view with the corresponding recorded frame will therefore reflect errors in the relatively small subset of model parameters representing or associated with the geometry that happens to render to that part of the 2D view, plus any errors in parameters that affect the view globally. Given a means of determining the subset of model parameters participating in a particular part of the 2D view, it is possible to selectively refine those parameters based on a mismatch of that part of the 2D view.

The method works by rendering identifiers [0005] of scene model geometry and its associated properties to additional render buffers [0006], one buffer for each type of identifier. This enables the matching stage to collect these identifiers while performing matching local to a part of the 2D view. By bundling the co-located identifiers with the mismatch information, the refinement stage is provided with the means to selectively refine the particular parameters responsible for the mismatch.

The rendered identifiers also enable an efficient means of partitioning the 2D view plane into areas taken up by projected visible model elements.

Since a particular model element can participate in multiple views and adjacent view parts, a means of aggregating mismatches per identifier is detailed that enables the refinement stage to easily take into account all mismatches pertaining to a particular model parameter.

### DETAILED DESCRIPTION OF THE INVENTION

The diagram shown in drawing 1 represents a broader system as part of which the invention is of use. It aims to provide an example of the operational context for the invention. The diagram does not assume a specific implementation for the processing, data flow, and data storage it depicts. The current state of the art suggests hardware implementations for the 3D to 2D rendering, matching, and feature extraction, with the remainder of the processing done in software.

a) One or more cameras record a stream of frames.

b) Features that can be matched to (e.g. edges) are extracted from the recorded camera frames.

c) The raw frame data and corresponding extracted features are stored in a record buffer.

d) Record buffers make the frame datasets available to the match stage. Memory limitations dictate that not every frame dataset can be retained. The frame pruning should favor the retention of frames corresponding to diverse viewpoints (stereoscopic, or historical) so as to prevent the RMR problem from being underdetermined (surfaces that remain hidden cannot be refined).

e) Interpolation or extrapolation of the model returns a snapshot of the time dependent 3D scene model at a particular past time, or extrapolated to a nearby future time.

f) Transfer of the model snapshots provides input for the 3D to 2D rendering stage. In addition to conventional input, identifiers of the model elements to which the various bits of geometry correspond are also passed along for joint rendering.

g) 3D to 2D rendering operates as outlined under [0003]. In addition to the conventional types of rendering, the pipeline is set up to also render identifiers using the methods detailed in the present application.

h) In case of supervised or semi-autonomous applications, the rendered model can be displayed via a user interface to allow inspection of or interaction with the scene model.

i) Render buffers receive the various types data rendered for a model snapshot: color values, z values, identifiers, texture coordinates and so on.

j) The match stage compares the render buffers to the record buffers. Mismatch information is parceled up with model identifiers and transferred to an aggregation buffer. To prevent overtaxing the refinement stage, the degree of mismatch can be compared to a threshold below which mismatches are ignored.

k) The mismatch parcels are sorted into lists per model element via the included identifiers. The mismatches are aggregated until the match stage completes. This ensures that all mismatches pertaining to the same model element are available before refinement proceeds.

l) Refinement makes adjustments to the model based on the mismatches, the current model state, and any domain knowledge. The adjusted model is tested during the next render and match cycle. Efficient execution of this task is a complex undertaking requiring software such as an expert system.

m) The model storage contains data structures representing the elements of the 3D scene model.

n) Tessellation produces polygon meshes suitable for rendering from mathematical or algorithmic geometry representations. Such representations require fewer parameters to approximate a surface, and thereby reduce the dimensionality of the refinement search space.

o) The RMR method aims to automatically produce a refined 3D scene model of the actual environment. The availability of such a model enables applications. For different application types, APIs can be created that help extract the required information from the scene model. Autonomous robotics applications can benefit from a planning API that assists in “what if” evaluation for navigation or modeling of the outcome of interactions with the environment.

p) Computer vision applications can benefit from an analysis API that helps yield information regarding distances, positions, volumes, collisions, and so on.

The rendering of discrete valued identifiers can be detailed for standard 3D to 2D rendering pipelines [0003] that process surface geometry as polygons. The vertices defining the polygons project to particular 2D view coordinates for a temporal interpolation (snapshot) of the time dependent scene model. An identifier of a geometry associated model element can be stored with all the vertices describing that geometry as customary for color values, alpha values, and surface normals. On rasterization, these identifiers are copied into the covered 2D raster positions of the render buffer reserved for that type of identifier, just like color values are copied to the frame buffer when rendering using flat shading (no variation over the covered 2D raster positions). This copying is subject to z-comparison so that only the identifiers of the front most surface are present in the render buffer once all geometry has been rendered.

Identifiers can also be continuous valued, conceptually that is: their representation must necessarily involve a limited number of bits and is therefore strictly speaking discrete valued. For instance, a point on a parametric surface is described using two continuous variables. When the model geometry contains such surfaces, it is helpful to refinement to be provided with the precise position on a parametric surface that participated in a mismatch so that the right part of the surface can be deformed to reduce the mismatch. This surface position can be determined from the parametric variables so that these qualify as identifiers as they allow refinement to locate the right part of the surface when passed along with a mismatch. Note though that this does not resolve which surface or object the raster position pertained to so that a discrete valued identifier will be required in addition.

The rendering of continuous valued identifiers using a rendering pipeline that processes polygons proceeds in perfect analogy to the rendering of texture coordinates. The identifier value at each vertex of the tessellated surface is stored with that vertex. On rasterization, these vertex-associated identifier values are interpolated before being stored into the identifier's render buffer. For details on the requisite calculations refer for example to the section on polygon rasterization in the OpenGL specification (downloadable from www.opengl.org). For precision, the interpolation should be perspective correct, particularly when the tessellation is coarse. The procedure is subject to z-comparison.

The rendering and corresponding feature extraction is performed for a series of model snapshots that match the times and viewpoints of each of the frame data sets retained in the record buffers. Subsequently, mismatches can be determined. Information specifying the time and identifying the viewpoint is bundled with other mismatch information so that the refinement stage knows what time and camera the mismatches it receives apply to.

Before matching, the 2D view plane is partitioned into 2D parts for which local matching is to take place. Any partitioning with 2D parts inside which a fraction of the model elements render and outside which the majority of the model elements render will do. For example, subdividing the view plane into an eight by six grid of square tiles (assuming a 4:3 aspect ratio) is a reasonable choice for scenes where the objects are at intermediate distance from the camera.

There is a particular adaptive means of partitioning the view plane that is efficient in the sense that the number of model elements participating in multiple 2D parts is minimized, thereby establishing a maximal decoupling of parameter subsets. This partitioning is based on the rendering of discrete identifiers for each object or visually distinct surface in the model. By collecting the set of 2D raster positions to which the same identifier is rendered, e.g. using a flood fill algorithm without writes applied to the identifier render buffer or by building per-identifier linked lists of raster positions during the rendering to the identifier buffer, the view area covered by the visible part of an object can be established. If the scene model is bounded by a sphere or cube, or the identifier render buffer is initialized to a unique default value before rendering, the 2D view will be wholly covered by a jigsaw puzzle of areas with constant identifiers so that a valid partitioning for use in local matching is established.

Matching collects the differences between the content of the record buffers (raw pixel data and/or extracted features) and comparable content of the render buffers. If features such as edges were extracted on recording the camera frames, the same extraction, or some rendering equivalent will need to be performed for the rendered frames.

Local matching is performed across the extent of each 2D part of the chosen partitioning of the 2D view plane. For each 2D part, the identifiers co-located with the part or associated with any matched features co-located with the part are bundled with the mismatch information. If required for refinement, the identifiers of adjacent 2D parts can be included as well.

The bundling of the identifiers allows the refinement stage to target the model parameters that are or are likely to be involved in causing a particular local mismatch so that these can be selectively tuned to reduce that mismatch.

To assist refinement of model parameters that affect the whole view, a global matching (covering the entire 2D view plane) can be performed as well.

Particular identifiers can recur in multiple mismatches, for example for mismatches of adjacent 2D parts or for mismatches belonging to different views of the same geometry. It is therefore advantageous to aggregate the mismatches into lists per identifier. If this is done before commencing with refinement, the refinement stage will be able to process all mismatches pertaining to a particular model element in unison. The refinement suggestions as determined from these multiple mismatches can be averaged before tuning the model parameters. Since the total collection of mismatch information is at risk of becoming prohibitive in size, it is advisable to discard instead of aggregate mismatches if their degree of mismatch lies below some tuneable threshold.

The reader should appreciate that there are many different possibilities for representing geometry in a scene model. The steps taken by refinement will vary with the representation used. Even for a given representation, there is a lot of freedom in choosing the particulars of refinement. Furthermore, there are many means of extracting features from frames. The present application refrains from prescribing data representations, refinement steps, feature extraction, or matching comparison since its methods are applicable for any choice of these particulars.

What is claimed is:

1. A method for decoupling 3D scene model parameters so as to allow their largely independent optimisation comprising:
the propagation of model element identifiers from the model, via the rendering pipeline, to render buffers;
the partitioning of render buffers in terms of 2D frame plane subsets so as to allow for a localized match;
an efficient means of performing such partitioning;
the parcelling up of model element identifiers with localized match results for propagation to the refinement stage;
the selective adjustment of model parameters based on match results by virtue of the included identifiers; and
the aggregation of match results per model parameter before making said adjustments.
